(19) United States
(12) Patent Application Publication
(10) Pub. No.: US 2025/0159361 A1
(43) Pub. Date: May 15, 2025

(54) MR DEVICE, AND METHOD FOR ELIMINATING IMAGE FLICKER IN THE MR DEVICE

(71) Applicant: GravityXR Electronics and Technology Co., Ltd., NINGBO (CN)

(72) Inventors: Chengrui LE, NINGBO (CN); Rui ZHANG, NINGBO (CN); Shuang WANG, NINGBO (CN); Chaohao WANG, NINGBO (CN)

(73) Assignee: GravityXR Electronics and Technology Co., Ltd., NINGBO (CN)

(21) Appl. No.: 19/026,195

(22) Filed: Jan. 16, 2025

Related U.S. Application Data
(63) Continuation of application No. PCT/CN2023/106691, filed on Jul. 11, 2023.

(30) Foreign Application Priority Data
Aug. 24, 2022 (CN) 202211020424.5
Aug. 24, 2022 (CN) 202211021642.0

(51) Int. Cl. H04N 23/745; H04N 23/73

(52) U.S. Cl. CPC H04N 23/745; H04N 23/73

(57) ABSTRACT

The disclosure provides an MR device and a method for eliminating image flicker in an MR device. The method includes: in response to a presence of ambient light flicker that triggers human eye perception, determining a flicker frequency of the ambient light flicker; determining whether the display module has a specific operating frequency according to a working status of the MR device; in response to having the specific operating frequency and a mismatch between the specific operating frequency and the flicker frequency, controlling the display module to display target images at the specific operating frequency at all times, and at least dynamically adjusting a target shooting frequency of the camera module according to the flicker frequency and the specific operating frequency; and controlling the camera module to obtain original images at the target shooting frequency, and the target image is obtained at least based on the original image.

### CROSS REFERENCE TO RELATED APPLICATION

This application is a continuation of International Patent Application No. PCT/CN2023/106691, filed on Jul. 11, 2023, which claims the priority of a patent application with a filing date of Aug. 24, 2022, a Chinese application number 202211020424.5, and a title of “An MR device and a method for eliminating image flicker therein”, as well as the priority of a patent application with a filing date of Aug. 24, 2022, a Chinese application number 202211021642.0, and a title of “An MR device and a method for eliminating image flicker therein”, which are hereby incorporated by reference in their entireties.

### FIELD

The disclosure relates to a field of image processing, in particular to an MR device and a method for eliminating image flicker in the MR device.

### BACKGROUND

GPU rendering refresh rate, display refresh rate, camera sensor refresh rate and exposure time settings of the existing mixed reality (MR) products in the market are based on multiple user experience indicators, as well as software and hardware performance limitations, but do not take into account the effects of ambient light change frequency and the brightness change frequency of the captured object. So, under different ambient light flicker frequency conditions, the display, camera, and rendering parameters of the existing MR products will not be properly set to avoid visible flicker to the naked eye. This is because the existing products in the market generally do not provide high-performance mixed reality or perspective functions, and the refresh rate of the display and camera generally do not exceed a multiple frequency of the mains frequency, such as 100 Hz in Chinese mainland. So, the problem of image flicker caused by ambient light flicker has not received sufficient attention. In the next generation of high-performance mixed reality products, with the increasing demand for display images and user experience, this problem must be properly resolved.

### SUMMARY

A brief overview of one or more aspects is provided below to provide a basic understanding of these aspects. The summary is not an extensive overview of all of the aspects that are contemplated, and is not intended to identify key or decisive elements in all aspects. The sole purpose of the summary is to present some concepts of one or more aspects in a simplified form as a prelude to the more detailed description that is presented later.

In order to solve the problem of image flicker caused by ambient light flicker in MR products, the disclosure provides an MR device and a method for eliminating image flicker in an MR device.

The MR device provided in the second aspect of the disclosure at least includes a camera module and a display module. The method for eliminating image flicker in the MR device provided in the first aspect of the disclosure includes: in response to a presence of ambient light flicker that triggers human eye perception, determining a flicker frequency of the ambient light flicker; determining whether the display module has a specific operating frequency according to a working status of the MR device; in response to having the specific operating frequency and a mismatch between the specific operating frequency and the flicker frequency, controlling the display module to display target images at the specific operating frequency at all times, and at least dynamically adjusting a target shooting frequency of the camera module according to the flicker frequency and the specific operating frequency; and controlling the camera module to obtain original images at the target shooting frequency, and the target images are obtained at least based on the original images.

The operating frequency of the display module of the MR device is related to the final viewing experience of the user. If the display module of the MR device has a specific operating frequency, in the disclosure, the display module is controlled to operate at the specific operating frequency at all times to ensure the viewing experience of the user. On the other hand, in order to eliminate the problem of display image flicker caused by the ambient light flicker, the disclosure at least adjusts the target shooting frequency of the camera module to eliminate the flicker of the display image caused by the ambient light flicker.

In one embodiment of the above method, in one embodiment, the step of at least dynamically adjusting the target shooting frequency of the camera module according to the flicker frequency and the specific operating frequency further includes: maintaining the target shooting frequency of the camera module at the specific operating frequency at all times; and dynamically adjusting exposure time of the camera module or performing brightness compensation on the original image according to the flicker frequency and the specific operating frequency.

According to the above embodiment, since the source of the final displayed target image is the original image obtained by the camera module. If the camera module and the display module are maintained to be at the same operating frequency, it will not cause missing or abrupt changes in the image. In this embodiment, due to the mismatch between the specific operating frequency and the flicker frequency, the flicker problem caused by the ambient light flicker can be further eliminated by adjusting the exposure time of the camera module or performing the brightness compensation on the original image. Thus, it is possible to eliminate the image flicker and improve the user experience while ensuring the coherence of the image.

In one embodiment of the above method, in one embodiment, the step of dynamically adjusting exposure time of the camera module or performing brightness compensation on the original image according to the flicker frequency and the specific operating frequency further includes: in response to the specific operating frequency being less than the flicker frequency, adjusting the exposure time of the camera module; or in response to the specific operating frequency being greater than the flicker frequency, and/or in response to a presence of flicker frequencies, performing the brightness compensation on the original image, and the target image is obtained based on the original image after the brightness compensation.

In one embodiment of the above method, in one embodiment, the camera module is adjusted to match the flicker period of ambient light.

In one embodiment of the above method, in one embodiment, the step of performing the brightness compensation on the original image further includes: for a preset number of historical original images prior to a current original image, separately obtaining a pixel brightness value of each pixel or a regional average brightness value of each local region from each of the historical original images; and performing the brightness compensation on the current original image based on the pixel brightness values or the regional average brightness values of the historical original images.

In one embodiment of the above method, in one embodiment, the step of separately obtaining a pixel brightness value of each pixel or a regional average brightness value of each local region from each of the historical original images further includes: obtaining a pixel chromaticity and brightness value of each pixel or a regional average chromaticity and brightness value of each local region form each of the historical original images based on each color channel, and the step of performing the brightness compensation on the current original image based on the pixel brightness values or the regional average brightness values of the historical original images further includes: for each color channel of the current original image, performing the brightness compensation based on the pixel chromaticity and brightness values or the regional average chromaticity and brightness values corresponding to the color channel of the historical original images.

According to the above embodiment, when performing brightness compensation on the original image to eliminate the image flicker caused by the ambient light flicker, the chromaticity brightness value is further adjusted, to not only consider the brightness of the image, but also compensate for the color changes caused by the brightness changes, resulting in smaller differences between the continuous images finally displayed to eliminate the flicker.

In one embodiment of the above method, in one embodiment, the step of performing the brightness compensation on the original image also includes: determining a flicker region in the current original image based on the regional average brightness value of the historical original images, and the step of performing the brightness compensation on the current original image based on the regional average brightness values of the historical original images further includes: for the flicker region of the current original image, performing the brightness compensation based on the regional average brightness values in the flicker region of the historical original images.

According to the above embodiment, in response to only some regions in the entire image are flickering, this embodiment can effectively reduce the amount of data processing required for brightness compensation by adjusting the brightness of local regions, to reduce the workload of the processor and lowering power consumption.

In one embodiment of the above method, in one embodiment, the step of dynamically adjusting the target shooting frequency of the camera module according to the flicker frequency and the specific operating frequency further includes: in response to a presence of only one single flicker frequency that is less than the specific operating frequency, maintaining the target shooting frequency of the camera module not greater than the flicker frequency at all times; and generating intermediate images corresponding to the specific working frequency based on the original images obtained by the camera module at the target shooting frequency, and the target image is obtained based on the intermediate image.

According to the above embodiment, by ensuring that the target shooting frequency of the camera module is not greater than the flicker frequency, the frequency difference between the target shooting frequency and the ambient light flicker frequency can be eliminated, to eliminate the problem of image flicker at the source. However, due to the mismatch between the shooting frequency and the display frequency, the final image that the user sees is still flickering, jumping, or missing. Therefore, in this embodiment, by generating intermediate images, it is possible to overcome the problem of the image flicker and the mismatch between the shooting frequency and the final display frequency.

In one embodiment of the above method, in one embodiment, the MR device further includes a rendering module. The method further includes: determining whether the rendering module has a specific rendering frequency, and in response to the rendering module having the specific rendering frequency, and the specific rendering frequency not matching the specific operating frequency, controlling the rendering module to generate rendered images at the specific rendering frequency, and generating intermediate rendered images corresponding to the specific operating frequency based on the rendered images at the specific rendering frequency, and the target image is also obtained based on the intermediate rendered image; or in response to the rendering module not having the specific rendering frequency, controlling the rendering module to generate rendered images at the specific operating frequency, and the target image is also obtained based on the rendered image.

Furthermore, in the disclosure, the working status of each module of the MR device can be comprehensively controlled to provide users with an MR device with better viewing effects. In this embodiment, by generating intermediate images, it is also possible to overcome the problem of mismatch between the rendering frequency, the display frequency, and the shooting frequency while ensuring the rendering effect of the final displayed image.

In one embodiment of the above method, in one embodiment, in response to a presence of only one single flicker frequency and the display module not having the specific operating frequency, maintaining the target shooting frequency of the camera module at the flicker frequency at all times, and controlling the display module to display target images at the flicker frequency.

In one embodiment of the above method, in one embodiment, the step of determining whether the display module has a specific operating frequency according to a working status of the MR device further includes: determining whether the display module has a specific operating frequency according to a working mode of the MR device and a display content of the display module, and in response to the MR device being in an energy-saving mode, determining the display module has a specific operating frequency less than a first preset threshold; in response to the MR device being in a high-performance mode, determining the display module has a specific operating frequency greater than a second preset threshold; and in response to the display content of the display module including a video source at a specific frequency, determining the specific operating frequency of the display module to be a multiple of the specific frequency of the video source.

The second aspect of the disclosure also provides an MR device. The MR device at least includes a camera module and a display module, and the MR device further includes at least one processor; and a memory coupled to the at least one processor, and the memory includes an instruction stored therein. When the instruction is executed by the at least one processor, the MR device performs the method for eliminating image flicker in the MR device as described in any one embodiment of the disclosure.

The third aspect of the disclosure also provides a non-transitory computer-readable storage medium, storing a computer instruction thereon. When the computer instruction is executed by a processor, the method for eliminating image flicker in the MR device as described in any one embodiment of the disclosure.

According to the MR device and the method for eliminating image flicker in the MR device provided in the disclosure, while ensuring the optimal display frequency, the working status of the MR device is comprehensively adjusted to at least adjust the shooting frequency of the imaging module to eliminate the problem of the display image flicker caused by the ambient light flicker, to eliminate the flicker while ensuring the performance of the MR device and provide users with excellent visual experience.

In addition, in order to solve the problem of the image flicker caused by the ambient light flicker, the disclosure can also match the ambient light flicker by adjusting the relevant shooting parameters of the camera module, to avoid the problem of the image flicker caused by the ambient light flicker. However, due to the MR device not only includes the camera module, but also includes a display module, etc. Although changing the relevant shooting parameters of the camera module can overcome the problem of the image flicker when generating the original image, it has caused the problem of frequency mismatch between the camera module and the display module. This ultimately results in misalignment, frame skipping, and other issues in the target image displayed by the display module, and still does not improve the problem of flickering in the image that users see through the display device of the MR device.

In order to solve the problem of the image flicker caused by the lack of consideration for the ambient light flicker in VR, AR or MR products in the existing technology, and to solve the secondary problem of the display image flicker or instability caused by imaging, rendering, and display frequency mixing in order to solve the problem of the ambient light flicker, the disclosure also provides an MR device and a method for eliminating image flicker in a MR device.

The MR device provided in the fifth aspect of the disclosure at least includes a camera module and a display module. The method for eliminating image flicker in the MR device provided in the forth aspect of the disclosure includes: in response to a presence of ambient light flicker that triggers human eye perception, determining a flicker frequency of the ambient light flicker; determining whether the display module has a specific operating frequency according to a working status of the MR device; in response to a presence of only one single flicker frequency and a presence of specific operating frequency that is greater than the flicker frequency, maintaining the target shooting frequency of the camera module not greater than the flicker frequency at all times; generating intermediate images corresponding to the specific working frequency based on original images obtained by the camera module at the target shooting frequency; and controlling the display module to display the target images, obtained based on the intermediate images, at the specific operating frequency.

In one embodiment of the above method, in one embodiment, the step of generating intermediate images corresponding to the specific working frequency based on original images obtained by the camera module at the target shooting frequency further includes: at a target time corresponding to the specific operating frequency, generating the intermediate image of the target time based on two frames of original images before and after the target time.

In one embodiment of the above method, in one embodiment, the step of generating intermediate images corresponding to the specific working frequency based on original images obtained by the camera module at the target shooting frequency further includes: at a target time corresponding to the specific operating frequency, predicting the intermediate image of the target time based on a change pattern of a preset frame number of original images before the target time, and the original image that is one frame before the target time.

In one embodiment of the above method, in one embodiment, the step of generating intermediate images corresponding to the specific working frequency based on original images obtained by the camera module at the target shooting frequency further includes: obtaining view field movement data of a user according to a positioning sensor of the MR device; and at a target time corresponding to the specific operating frequency, performing at least one of parallel moving, scaling and distorting processes on the original image that is one frame before the target time based on the view field movement data, to generate the intermediate image of the target time.

In one embodiment of the above method, in one embodiment, the step of maintaining the target shooting frequency of the camera module not greater than the flicker frequency at all times further includes: maintaining the target shooting frequency of the camera module being the flicker frequency at all times.

In one embodiment of the above method, in one embodiment, the step of maintaining the target shooting frequency of the camera module not greater than the flicker frequency at all times further includes: maintaining the target shooting frequency of the camera module less than the flicker frequency at all times, and adjusting the target shooting frequency of the camera module to make the flicker frequency a multiple of the target shooting frequency.

In one embodiment of the above method, in one embodiment, in response to the target shooting frequency being less than the flicker frequency, the exposure time of the camera module is adjusted to match a flicker period of the ambient light flicker.

In one embodiment of the above method, in one embodiment, the MR device further includes a rendering module. The method further includes: determining whether the rendering module has a specific rendering frequency, and in response to the rendering module having the specific rendering frequency, and the specific rendering frequency not matching the specific operating frequency, controlling the rendering module to generate rendered images at the specific rendering frequency, and generating intermediate rendered images corresponding to the specific operating frequency based on the rendered images at the specific rendering frequency, and the target image is also obtained based on the intermediate rendered image; or in response to the rendering module not having the specific rendering frequency, controlling the rendering module to generate rendered images at the specific operating frequency, and the target image is also obtained based on the rendered image.

In one embodiment of the above method, in one embodiment, the step of determining whether the display module has a specific operating frequency according to a working status of the MR device further includes: determining whether the display module has a specific operating frequency according to a working mode of the MR device and a display content of the display module, and in response to the MR device being in an energy-saving mode, determining the display module has a specific operating frequency less than a first preset threshold; in response to the MR device being in a high-performance mode, determining the display module has a specific operating frequency greater than a second preset threshold; and in response to the display content of the display module including a video source at a specific frequency, determining the specific operating frequency of the display module to be a multiple of the specific frequency of the video source.

The fifth aspect of the disclosure also provides an MR device. The MR device at least includes a camera module and a display module, and the MR device further includes at least one processor; and a memory coupled to the at least one processor, and the memory includes an instruction stored therein. When the instruction is executed by the at least one processor, the MR device performs the method for eliminating image flicker in the MR device as described in any one embodiment of the disclosure.

The sixth aspect of the disclosure also provides a non-transitory computer-readable storage medium, storing a computer instruction thereon. When the computer instruction is executed by a processor, the method for eliminating image flicker in the MR device as described in any one embodiment of the disclosure.

According to the MR device and the method for eliminating image flicker in the MR device provided in the disclosure, it is possible to solve the problem of the image flicker or the instability caused by changes in the ambient light brightness and imaging, rendering, and display frequency mixing by adjusting the shooting parameters of the camera module and generating intermediate images based on the original images of the camera module. The disclosure provides a solution for camera devices and display devices to adopt any refresh rate, which can dynamically adapt to changes in ambient light and provide the possibility to improve the refresh rate of display devices, laying the foundation for further improvement and development of mixed reality performance.

### BRIEF DESCRIPTION OF THE DRAWINGS

The above embodiments will be better understood after reading the detailed description of the embodiments of the present disclosure in conjunction with the following figures. In the figures, components are not necessarily drawn to scale, and components having similar related features may have the same or similar reference numerals.

FIG. 1 shows a schematic diagram of structure of the MR device according to the second aspect of the disclosure.

FIG. 2 shows a flowchart of method for eliminating image flicker in the MR device according to the first aspect of the disclosure.

FIG. 3 shows a flowchart of specific implementation of the step S600 in the method according to the disclosure.

FIG. 4 shows a schematic diagram of structure of the MR device according to the fifth aspect of the disclosure.

FIG. 5 shows a flowchart of method for eliminating image flicker in the MR device according to the fourth aspect of the disclosure.

FIG. 6 illustrates a relationship between the ambient light flicker period, the display module frequency, and the camera module frequency in the disclosure.

### DETAILED DESCRIPTION OF EMBODIMENTS

The disclosure will be described in detail with reference to the following figures and the specific embodiments. Note that the aspects described below in conjunction with the following figures and the specific embodiments are exemplary only and should not be understood as any limitation of the scope of protection of the disclosure.

The following description is provided to enable implementation and use the disclosure and incorporate it into specific application background. Various variations and uses in different applications will be readily apparent, and the general principles defined in this article can be applied to a wide range of embodiments. Therefore, the disclosure is not limited to the embodiments provided herein, but should be granted the broadest scope consistent with the principles and novel features disclosed herein.

In the following detailed description, many specific details are elaborated to provide a more thorough understanding of the disclosure. However, it is evident the practice of the disclosure does not need to be limited to these specific details. In other words, the well-known structures and devices are shown in block diagram form without detailed illustration to avoid obscuring the disclosure.

The readers should note that all documents and literature submitted simultaneously with this specification and open to the public for inspection are incorporated herein by reference, and the contents of all such documents and literature are incorporated into this article by reference. Unless otherwise directly specified, all features disclosed in this specification (including any accompanying claims, abstract, and drawings) may be replaced by alternative features used to achieve the same, equivalent, or similar purposes. Therefore, unless otherwise explicitly specified, each disclosed feature is only an example of a set of equivalent or similar features.

It should be note that in the case of use, symbols left, right, front, back, top, bottom, forward, reverse, clockwise, and counterclockwise are only used for convenience purposes and do not imply any specific fixed direction. In fact, they are used to reflect the relative position and/or orientation between different parts of an object. In addition, the terms “first” and “second” are only used for descriptive purposes and cannot be understood as indicating or implying relative importance.

Note that in the case of use, further, better, even further, and even better is a simple beginning of another embodiment based on the aforementioned embodiment. The content following further, better, even further, and even better in combination with the aforementioned embodiment constitutes a complete embodiment. The several further, better, even further, or even better following the same embodiment can be arbitrarily combined to form another embodiment.

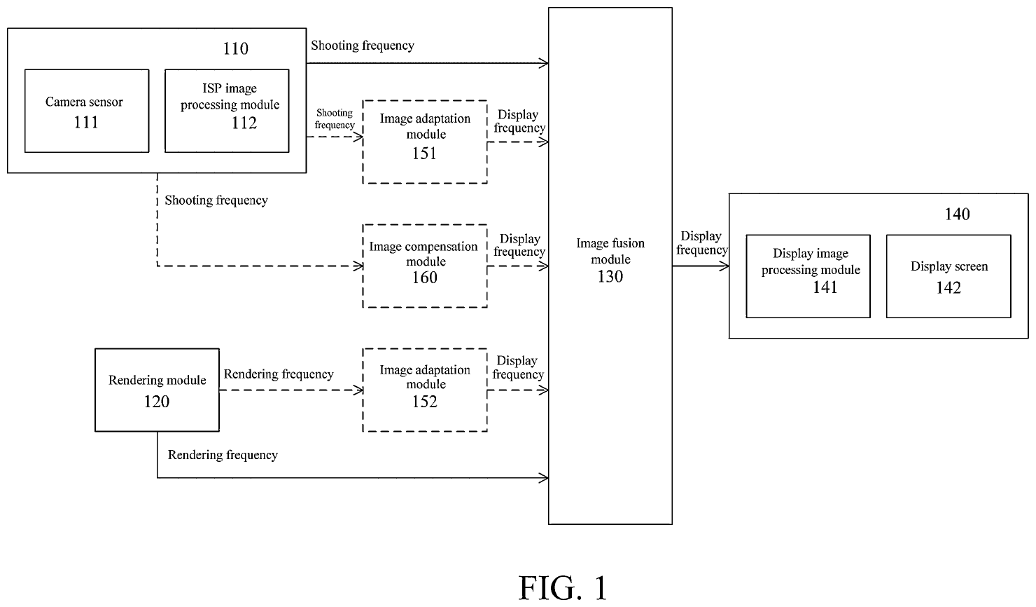

In order to solve a problem of an image flicker caused by an ambient light flicker in an MR product, the disclosure provides an MR device and a method for eliminating image flicker in the MR device. Firstly, please refer to FIG. 1 to understand the MR device provided in the second aspect of the disclosure, and refer to FIG. 1 to understand an application scenario of the method for eliminating image flicker in the MR device provided in the first aspect of the disclosure.

As shown in FIG. 1, the MR device provided in the second aspect of the disclosure at least includes a camera module 110 and a display module 140. The MR device processes the images captured by the camera module 110 and displays them on the display module 140.

In the embodiment shown in FIG. 1, the camera module 110 includes a camera sensor 111 and an ISP image processing module 112. The exposure time and shooting frequency of the camera sensor 111 can be adjusted. The processing frequency of the ISP image processing module 112 matches the shooting frequency of the camera sensor 111. The specific composition of the camera module 110 mentioned above is only illustrative and should not improperly limit the scope of protection of the present disclosure.

In the embodiment shown in FIG. 1, the display module 140 includes a display image processing module 141 and a display screen 142. The frequency of processing the target image to be displayed by the display image processing module 141 can be adjusted. The refresh rate of the display screen 142 matches the processing frame rate of the display image processing module 141.

In one embodiment, the MR device processes the raw images captured by the camera module 110 through the rendering module 120 and the image fusion module 130. That is, the digital reality image output by the camera module 110 and the virtual digital image output by the rendering module 120 are fused through the image fusion module 130 to enhance and render the image obtained by the camera module 110, and output and display the mixed target image.

The ambient light can be affected by electronic lighting devices, such as artificial lighting and electronic display devices. Electronic devices generally have periodic modulation of brightness. For example, when the mains alternating current frequency of Chinese mainland is 50 Hz, LED lights and fluorescent lights have 100 Hz high-frequency brightness flickering. Although the human eye cannot see flicker above 90 Hz, when the refresh rate of the camera device mixes with the ambient light flicker frequency, new low-frequency components are produced. For example, when shooting an environment with 100 Hz LED lighting at a shooting frequency of 120 Hz, a 20 Hz differential frequency flicker will be observed. Under the existing products and designs, if the refresh rate of the MR device is higher than 100 Hz or the camera exposure time is set to less than 100 ms, differential frequency flicker will occur without compensation function.

Due to a presence of modules in the MR device, in order for the user to observe the relevant images without flicker through the display module 140, it is necessary to comprehensively compensate and adjust the modules in the MR device.

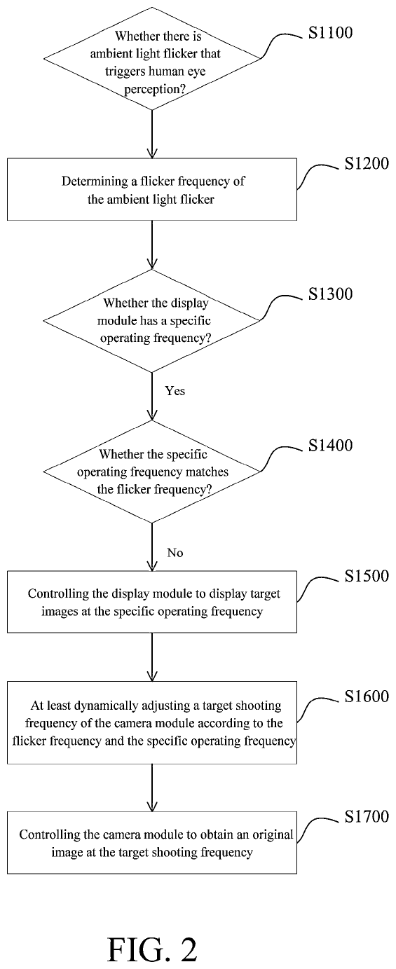

Please refer to FIG. 2 to further understand the method for eliminating image flicker in the MR device provided in the first aspect of the disclosure. As shown in FIG. 2, the method provided in the first aspect of the disclosure includes:

Step S1100: determining whether there is ambient light flicker that triggers human eye perception. In response to a presence, execute a step S1200: determining a flicker frequency of the ambient light flicker.

In a step S1300, determine whether the display module has a specific operating frequency, and in a step S1400, determine whether the specific operating frequency matches the flicker frequency.

In response to a presence of a specific working frequency and that the specific operating frequency does not match the flicker frequency, execute a step S1500, control the display module to display the target image at the specific operating frequency at all times, and executed a step S1600, dynamically adjust the target shooting frequency of the camera module according to the flicker frequency and the specific operating frequency. And in a step S700, control the camera module to obtain the original image at the target shooting frequency.

According to the step S1500, the final display effect of the MR device can be ensured, to ensure the visual perception of the user. According to the step S1600, the working status of each module of the MR device is dynamically adjusted to overcome the problem of the image flicker caused by the ambient light flicker in an optimal way.

In the step S1100, the ambient light flicker that triggers human eye perception refers to light flicker below 80-90 Hz. Although the human eye is a very complex system with significant individual differences, for a vast majority of people, they can perceive the light flicker below 80-90 Hz. At this time, the human eye can perceive changes in brightness and darkness. Flicker frequencies below 80-90 Hz are also known as visible flicker. The visible flicker is unacceptable for ordinary lighting or displays and is also desirable to eliminate in the MR device.

According to an embodiment, in the step S1100, periodic changes in an entire field of view or a local area of view of the ambient light can be sensed and analyzed through an ambient light sensing sensor or the camera module 110. At the same time, when determining whether the periodic changes of the ambient light will trigger human eye perception, it is comprehensively determined whether the ambient light will trigger human eye perception by determining whether there are periodic changes within a specific frequency range in the entire field of view or the local field of view, and the magnitude of the changes exceeds a specific threshold.

In the disclosure, in response to the presence of the ambient light flicker that triggers human eye perception, it is firstly necessary to determine the flicker frequency of the ambient light flicker. Technicians in this field can use existing or future means to determine the flicker frequency of the ambient light. The specific determination of the flicker frequency of the ambient light should not improperly limit the scope of protection of the disclosure.

Furthermore, when there is the ambient light flicker that triggers human eye perception, it is necessary to further determine whether the flicker frequency of the ambient light flicker that triggers human eye perception matches the operating frequency of the display module of the MR device. The operating frequency of the display module includes a display device refresh rate (the number of frames displayed by a display device per second, or the reciprocal 1/T of the duration T each frame stays on the screen), and a display signal processing frame rate (the number of frames processed by a display image processing circuit per second, or the reciprocal 1/T of the duration T required for each frame of image processing). Generally speaking, the display device refresh rate and the display signal processing frame rate remain the same.

In one embodiment, it is firstly necessary to determine whether the display module has a specific operating frequency based on the working status of the MR device in the step S1300. Furthermore, in one embodiment, determine whether the display module has a specific operating frequency according to a working mode of the MR device and a display content of the display module. In one embodiment, in response to the MR device being in an energy-saving mode, the display module has a specific operating frequency less than a first preset threshold. In response to the MR device being in a high-performance mode, the display module has a specific operating frequency greater than a second preset threshold. In response to the display content of the display module including a video source at a specific frequency, the specific operating frequency of the display module is a multiple of the specific frequency of the video source.

As described above, the most intuitive feeling for users when using the MR device is visual experience, therefore, the working status of the display module will determine the user experience. For this reason, if the display module already has a specific working mode, even if there is the ambient light flicker that will cause the screen to flicker, it is still necessary to maintain the display module in the specific working mode, that is, in the step S1500, control the display module to display the target image at the specific working frequency at all times.

Due to the mismatch between the ambient light flicker frequency and the specific operating frequency of the display module, that is to say, in the case of the ambient light flicker frequency is not equal to the specific operating frequency, there is not a frequency multiplication relationship, and there is a frequency difference between the two, it is necessary to comprehensively adjust the working status of the camera module and other modules to overcome the problem caused by the ambient light flicker.

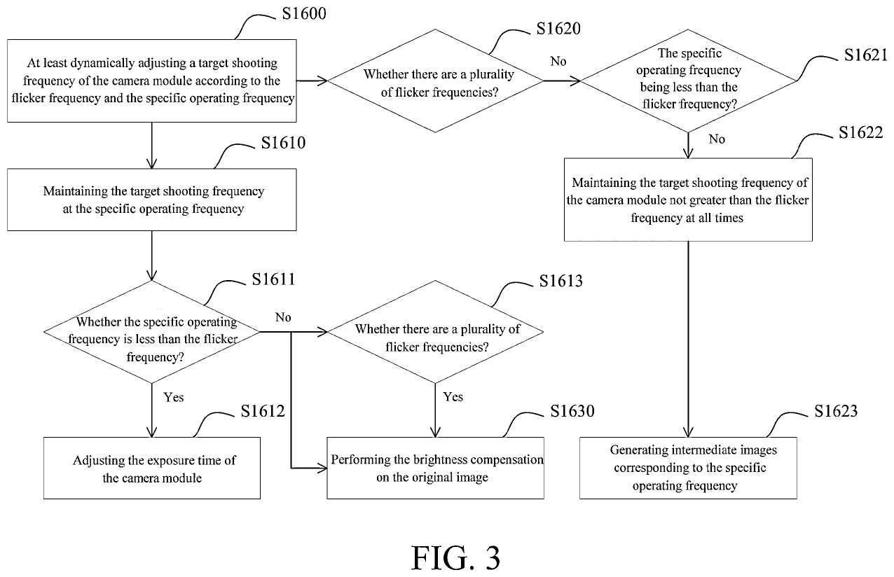

Please further refer to FIG. 3 to understand the specific implementation of dynamically adjusting the target shooting frequency of the camera module according to the flicker frequency and the specific operating frequency in the step S1600 of the disclosure. The target shooting frequency of the camera module is the number of frames captured by the camera module per second, or in other words, the reciprocal 1/T of the duration T of each frame captured.

In one embodiment, the target shooting frequency is firstly set to always be maintained at the specific working frequency, that is, execute a step S1610. In this case, due to the consistent operating frequency of the camera module and display module, the frequency of image processing in the MR device is consistent, and there will be no misalignment of the internal images.

On the premise of the step S1610, since the shooting frequency is the specific operating frequency, in other words, there is a mismatch between the shooting frequency and the ambient light flicker frequency. Therefore, additional processing may be necessary to eliminate the ambient light flicker.

Furthermore, execute a step S1611 to determine whether the specific operating frequency is less than the flicker frequency. In response to the specific operating frequency being less than the flicker frequency, in one embodiment, execute a step S1612 to adjust the exposure time of the camera module to eliminate the image flicker caused by the ambient light flicker. In one embodiment, the exposure time of the imaging module is adjusted to follow and equal to the ambient light flicker period. For example, in conjunction with FIG. 1, adjust the exposure time of a camera sensor 111 to eliminate the screen flicker. Due to the ambient light flicker period is correlated with the ambient light flicker frequency, the ambient light flicker period can be determined in real-time by determining the ambient light flicker frequency in the step S1200. Therefore, the exposure time of the camera module can be dynamically controlled to match the ambient light flicker period, and the flicker of the original image can be eliminated in the camera module 110.

In response to the specific operating frequency being greater than the flicker frequency in the step S1611, a step S1630 should be executed to perform brightness compensation on the original image. Furthermore, if flicker frequencies are determined in the ambient light flicker in the step S1200, the step S1630 should also be executed to perform brightness compensation on the original image. That is to say, in response to the specific operating frequency being greater than the flicker frequency, and/or in response to a presence of flicker frequencies, perform the brightness compensation on the original image.

Taking the embodiment shown in FIG. 1 as an example, performing the brightness compensation on the original image output by the camera module 110 in the image compensation module 160 to eliminate the flicker present in the original image. In one embodiment, performing brightness compensation on the original image further includes: for a preset number of historical original images prior to a current original image, separately obtaining a pixel brightness value of each pixel or a regional average brightness value of each local region from each of the historical original images; and performing the brightness compensation on the current original image based on the pixel brightness values or the regional average brightness values of the historical original images.

It should be noted that in the disclosure, it is firstly necessary to determine a pixel brightness value of each pixel of each of the historical original images, or the average brightness value of each local area from each of the historical original images. The above average brightness values are based on the average brightness values of pixels in each local area of the same historical original image. In the disclosure, the overall brightness value of the historical original images are not averaged to obtain the compensated brightness value. However, it is a comprehensive band stop filtering according to the brightness values of each pixel or the average brightness value of local areas from each of the historical original image, in order to reduce or eliminate the flicker.

Furthermore, separately obtaining a pixel brightness value of each pixel or a regional average brightness value of each local region from each of the historical original images includes: obtaining a pixel chromaticity and brightness value of each pixel or a regional average chromaticity and brightness value of each local region form each of the historical original images based on each color channel (Rn, Gn, Bn); and performing the brightness compensation on the current original image based on the pixel brightness values or the regional average brightness values of the historical original images further includes: for each color channel of the current original image, performing the brightness compensation based on the pixel chromaticity and brightness values or the regional average chromaticity and brightness values corresponding to the color channel of the historical original images.

The image flicker caused by the ambient light not only leads to changes in brightness, but also reflects differences in color. In the disclosure, the brightness values of the color channels are further compensated to more naturally eliminate the problem of the image flicker.

In the first aspect, performing the brightness compensation on the original image also includes: determining a flicker region in the current original image based on the regional average brightness value of the historical original images, and performing the brightness compensation on the current original image based on the regional average brightness values of the historical original images further includes: for the flicker region of the current original image, performing the brightness compensation based on the regional average brightness values in the flicker region of the historical original images.

In the MR device, the image compensation module 160 analyzes the brightness values of each frame of the image, and the calculation required for brightness compensation is very large, which requires a lot of power consumption. In order to effectively reduce energy consumption during the brightness compensation, the concept of flicker area is proposed in the disclosure. That is to say, the local region where the flicker occurs in the image is firstly analyzed as the flicker area. When performing the brightness compensation, only the pixels in this region are compensated, which can greatly reduce computation and power consumption.

In another embodiment, in the step S1600, adjust the target shooting frequency of the camera module to associate with the flicker frequency. In this case, due to the mismatch between the shooting frequency of the camera module 110 and the specific working frequency of the display module 140, there is a misalignment of the images to be processed internally in the MR device. Therefore, it is necessary to adjust the image sequence captured based on the camera module in association with the flicker frequency to adapt to the specific working frequency of the display module 140.

In one embodiment, as shown in FIG. 3, it is firstly necessary to determine whether there are flicker frequencies in the ambient light flicker in a step S1620, and if there is only a single flicker frequency, determine whether the specific working frequency is less than the flicker frequency in a step S1621. If the specific working frequency is greater than the flicker frequency, it indicates that the display module 140 has a high display requirement. In this embodiment, execute a step S1622 to maintain the target shooting frequency of the camera module not greater than the flicker frequency at all times, to solve the problem of the original image flicker caused by the ambient light flicker from the source.

Furthermore, maintaining the target shooting frequency of the camera module not greater than the flicker frequency at all times includes maintaining the target shooting frequency of the camera module being the flicker frequency at all times or making the flicker frequency a multiple of the target shooting frequency, to match the target shooting frequency with the flicker frequency.

Due to the MR device is a complete product and only changes the target shooting frequency of the camera module, although it can overcome the problem of the image flicker when generating the original image, it has caused the problem of a frequency mismatch between the camera module and the display module. This ultimately results in misalignment, frame skipping, and other issues in the target image displayed by the display module.

Therefore, the first aspect of the disclosure converts the original image sequence of the flicker frequency into an intermediate image of the specific working frequency through an image adaptation module 151. In one embodiment, frame interpolation, time warping, or other existing or future methods can be used to address the problem of inconsistency between the image frequency output by the camera module and the image frequency displayed by the display module.

For example, the image sequence generated by the camera module is A1, A2, A3, etc., while the image sequence that the display module needs to display is B1, B2, B3, etc. Assuming that the time points of A1 and B1 are aligned, due to the frequency of the camera module is less than the frequency of the display module, the generation time of A2 is later than that of B2. Therefore, it results in missing images in frame B2.

In order to compensate for the above problems, in one embodiment, the above-mentioned adaptation process can be achieved through frame interpolation. In one embodiment, after obtaining A1 and A2, an image Ab2 corresponding to a time point B2 can be generated by integrating A1 and A2, and image fusion can be completed based on Ab2 for displaying.

In another embodiment, the above problems can be compensated through time distortion to achieve the adaptation process. In one embodiment, as it is an MR device, in order to obtain the original image corresponding to point B2, the closest image before the point B2 time (such as A1) can be used. By adjusting and moving the image position in the field of view based on the head space position, motion direction, and velocity information of the user, generate a new image at the time point.

By generating the new image to change the frequency of the original image sequence, it is possible to match the specific operating frequency of the display module to avoid frame skipping and discontinuity caused by changes in the shooting frequency of the camera module.

In the second aspect of the disclosure, the MR device further includes a rendering module 120. The rendering module 120 outputs a virtual digital image at a rendering frequency. An image fusion module 130 enhances and renders the image obtained by the camera module 110 by fusing based on the digital reality image generated by the camera module 110 and the virtual digital image output by the rendering module 120, and outputs and displays a mixed target image.

Generally speaking, the rendering frequency of the rendering module 120 is consistent with the specific operating frequency of the display module. In this case, the target image is obtained by fusing the original image (the intermediate image) and the rendered image.

But in some embodiments, there may be a specific rendering frequency that is inconsistent with the specific operating frequency, resulting in the inability to match during image fusion.

For this, in another embodiment, in response to a presence of the specific rendering frequency in the rendering module and the mismatch between the specific rendering frequency and the specific operating frequency, the rendering module is controlled to generate a rendered image at the specific rendering frequency. An image adaptation module 152 generates an intermediate rendered image corresponding to the specific operating frequency based on the rendered image at the specific rendering frequency, and the original image (intermediate image) and the intermediate rendered image can be fused at the specific operating frequency through the image fusion module 130 to obtain the target image.

The specific implementation of the image adaptation module 152 can refer to the specific implementation of the image adaptation module 151, such as adjusting the frequency of the rendered image sequence through frame interpolation, time warping, or other existing or future techniques, which will not be repeated here.

In the first aspect of the disclosure, in response to a presence of only one single flicker frequency and the display module does not have the specific operating frequency, maintain the target shooting frequency of the camera module being the flicker frequency at all times, and control the display module to display the target image at the flicker frequency. Thus, the problem of screen flickering can be solved in a simplest and lowest power consumption way.

In summary, when there are no specific requirements for the frame rate setting of each module in the MR device, or the optimal range of the frame rate setting is consistent with the ambient light flicker frequency, control the refresh rate (the shooting frequency) of the camera module, the display frame rate, and the image rendering frame rate to dynamically adjust according to the ambient light change frequency. The above unspecified requirements may include: the MR device does not need to consider reducing the frame rate to save energy, the display content of the display module of the MR device is not a fixed frame rate video source (such as a 24 Hz movie), so there is no need to set a specific display frame rate, and there is only one flicker frequency in the entire shooting field of the ambient light that reaches the flicker threshold.

When the optimal frame rate setting of the MR device is lower than the ambient light flicker frequency and there is only one flicker frequency in the entire shooting field of the ambient light reaches the flicker threshold, control the full frame or local refresh rate and frame rate to remain lower than the ambient light change frequency, and adjust the camera equipment to maintain the full frame or local exposure time of each frame consistent with the ambient light change period. The optimal frame rate setting of the MR device mentioned above may be lower than the ambient light flicker frequency, possibly due to the desire to reduce power consumption by lowering the operating frequencies of the rendering, imaging, ISP image processing, display, and display image processing modules; It may be due to the presence of a specific frequency video source in the displayed content (such as a movie shot at 24 Hz), which requires the display frame rate to be a multiple of the video source frame rate and cannot be consistent with the ambient light frequency.

When the ambient light contains one or more flicker frequencies that reach the flicker threshold in the entire shooting field, or when the optimal frame rate of each module of the MR device is higher than the ambient light flicker frequency, and when the storage and computing hardware required for digital image compensation of the MR device is sufficient, the average value of local pixels in the displayed image can be calculated. That is, perceiving and analyzing the periodic brightness change data collected by a camera sensor or an ambient light sensor, and performing digital signal compensation on each frame of the displayed image based on this to cancel out the global or local brightness change amplitude in a specific frequency range and reduce flicker.

The optimal frame rate of each module in the MR device is higher than the ambient light flicker frequency, which may be due to the large number of moving objects in the rendering or shooting scene of the device. It is necessary to increase the frame rate of each module to reduce delay and display dynamic ghosting, or it may be due to the device being a wearable headset that needs to update the display content in real-time to improve display realism and reduce the discomfort and health hazards of the user caused by factors such as delay and display dynamic ghosting.

When the optimal frame rate of each module in the MR device is higher than the ambient light flicker frequency, and when only one flicker frequency in the entire shooting field of the ambient light reaches the flicker threshold, control the frame rate of the imaging and shooting image processing to remain not greater than the ambient light frequency, and the rendering and display frame rate can exceed the ambient light frequency. When displaying the shooting image, techniques such as inter-frame interpolation or time distortion are used to obtain the image at the required display time point.

Therefore, the specific implementation of the disclosure to eliminate the problem of the image flicker caused by the ambient light flicker in the MR device has been described. According to the MR device and the method for eliminating image flicker in the MR device provided by the disclosure, while ensuring the optimal display frequency, the working status of the MR device is comprehensively adjusted to at least adjust the shooting frequency of the camera module to eliminate the problem of the display image flicker caused by the ambient light flicker, to eliminate flicker while ensuring the performance of the MR device and provide users with excellent visual experience.

The second aspect of the disclosure also provides an MR device, as shown in FIG. 1, and the MR device includes at least a camera module 110 and a display module 140, and further includes at least one processor; and a memory coupled to the at least one processor. The memory includes an instruction stored therein. When the instruction is executed by the at least one processor, cause the MR device to perform the method for eliminating image flicker in the MR device as described in any one embodiment of the disclosure. It should be noted that at least one processor mentioned above may include processors in the camera module 110 and the display module 140.

The third aspect of the disclosure also provides a non-transitory computer-readable storage medium, storing a computer instruction thereon. When the computer instruction is executed by a processor, the steps of the method for eliminating image flicker in the MR device as described in any one of the embodiments above are implemented. Please refer to the description above for details, which will not be repeated here. In addition, it can be understood that the above-mentioned computer-readable storage medium can also be in the form of a system, including computer-readable storage sub media, to jointly implement the steps of the method for eliminating image flicker in the MR device described above through the computer-readable storage media.

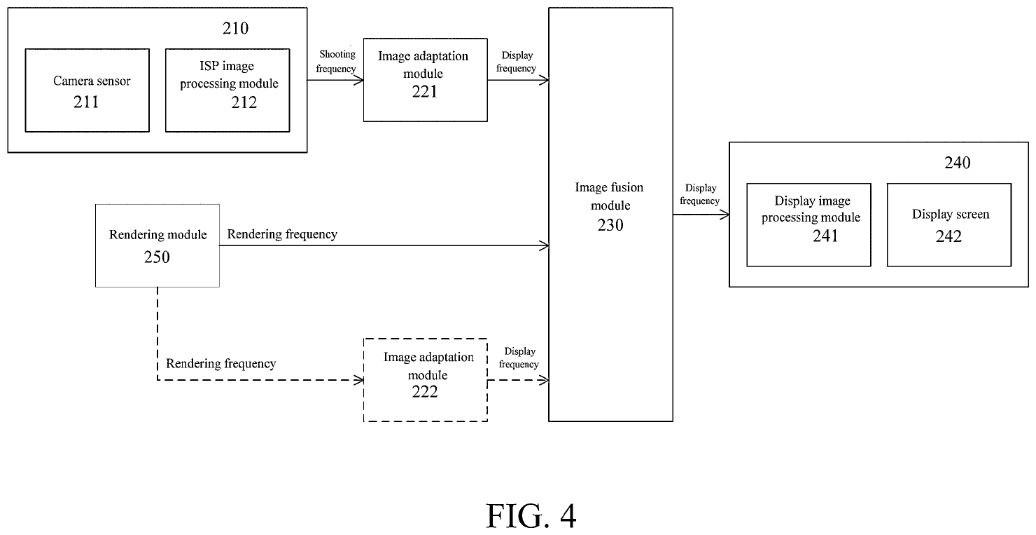

In addition, in order to solve a problem of an image flicker caused by an ambient light flicker in an MR product, the disclosure also provides an MR device and a method for eliminating image flicker in an MR device. Please refer to FIG. 4 to understand the MR device provided in the fifth aspect of the disclosure, and refer to FIG. 4 to understand an application scenario of the method for eliminating image flicker in the MR device provided in the fourth aspect of the disclosure.

As shown in FIG. 4, the MR device provided in the fifth aspect of the disclosure at least includes a camera module 210 and a display module 240. The MR device processes the images captured by the camera module 210 and displays them on the display module 240.

In the embodiment shown in FIG. 4, the camera module 210 includes a camera sensor 211 and an ISP image processing module 212. The exposure time and shooting frequency of the camera sensor 211 can be adjusted. The processing frequency of the ISP image processing module 212 matches the shooting frequency of the camera sensor 211. The specific composition of the camera module 210 mentioned above is only illustrative and should not improperly limit the scope of protection of the disclosure.

In the embodiment shown in FIG. 4, the display module 240 includes a display image processing module 241 and a display screen 242. The frequency of processing the target image to be displayed by the display image processing module 241 can be adjusted. The refresh rate of the display screen 242 matches the processing frame rate of the display image processing module 241.

In one embodiment, the MR device processes the raw images captured by the camera module 210 through the rendering module 250 and the image fusion module 230. That is, the digital reality image output by the camera module 210 and the virtual digital image output by the rendering module 250 are fused through the image fusion module 230 to enhance and render the image obtained by the camera module 210, and output and display the mixed target image.

The ambient light can be affected by electronic lighting devices, such as artificial lighting and electronic display devices. Electronic devices generally have periodic modulation of brightness. For example, when the mains alternating current frequency of Chinese mainland is 50 Hz, LED lights and fluorescent lights have 100 Hz high-frequency brightness flickering. Although the human eye cannot see flicker above 90 Hz, when the refresh rate of the camera device mixes with the ambient light flicker frequency, new low-frequency components are produced. For example, when shooting an environment with 100 Hz LED lighting at a shooting frequency of 120 Hz, a 20 Hz differential frequency flicker will be observed. Under the existing products and designs, if the refresh rate of the MR device is higher than 100 Hz or the camera exposure time is set to less than 100 ms, differential frequency flicker will occur without compensation function.

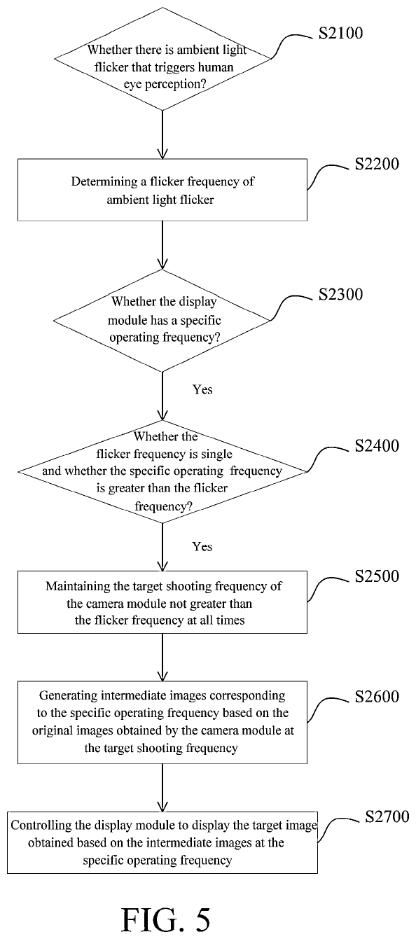

Please refer to FIG. 5 to further understand the method for eliminating image flicker in the MR device provided in the fourth aspect of the disclosure. As shown in FIG. 5, the method provided in the fourth aspect of the disclosure includes:

Step S2100: determining whether there is ambient light flicker that triggers human eye perception. In response to a presence, execute a step S2200: determining a flicker frequency of ambient light flicker.

In a step S2300, determine whether the display module has a specific operating frequency, and in a step S2400, determine whether the flicker frequency is single and whether the specific operating frequency is greater than the flicker frequency.

In response to a single flicker frequency and the specific operating frequency greater than the flicker frequency, execute a step S2500 to maintain the target shooting frequency of the camera module not greater than the flicker frequency at all times; In a step S2600, generate intermediate images corresponding to the specific operating frequency based on the original images obtained by the camera module at the target shooting frequency; And in a step S2700, control the display module to display the target image obtained based on the intermediate images at the specific operating frequency.

In the step S2100, the ambient light flicker that triggers human eye perception refers to light flicker below 80-90 Hz. Although the human eye is a very complex system with significant individual differences, for a vast majority of people, they can perceive the light flicker below 80-90 Hz. At this time, the human eye can perceive changes in brightness and darkness. Flicker frequencies below 80-90 Hz are also known as visible flicker. The visible flicker is unacceptable for ordinary lighting or displays and is also desirable to eliminate in the MR device.

According to an embodiment, in the step S2100, periodic changes in an entire field of view or a local area of view of the ambient light can be sensed and analyzed through an ambient light sensing sensor or the camera module 210. At the same time, when determining whether the periodic changes of the ambient light will trigger human eye perception, it is comprehensively determined whether the ambient light will trigger human eye perception by determining whether there are periodic changes within a specific frequency range in the entire field of view or the local field of view, and the magnitude of the changes exceeds a specific threshold.

In the disclosure, in response to the presence of the ambient light flicker that triggers human eye perception, it is firstly necessary to determine the flicker frequency of the ambient light flicker. Technicians in this field can use existing or future means to determine the flicker frequency of the ambient light. The specific determination of the flicker frequency of the ambient light should not improperly limit the scope of protection of the disclosure.

Furthermore, when there is the ambient light flicker that triggers human eye perception, it is necessary to further determine whether the flicker frequency of the ambient light flicker that triggers human eye perception is single and whether it is lower than the operating frequency of the display module in the MR device.

The single flicker frequency of the ambient light refers to only determining the presence of one single flicker frequency of the ambient light flicker in a step S2200, rather than flicker frequencies. The operating frequency of the display module includes a display device refresh rate (the number of frames displayed by a display device per second, or the reciprocal 1/T of the duration T each frame stays on the screen), and a display signal processing frame rate (the number of frames processed by a display image processing circuit per second, or the reciprocal 1/T of the duration T required for each frame of image processing). Generally speaking, the display device refresh rate and the display signal processing frame rate remain the same.

In one embodiment, it is firstly necessary to determine whether the display module has a specific operating frequency based on the working status of the MR device in the step S2300. Furthermore, in one embodiment, determine whether the display module has a specific operating frequency according to a working mode of the MR device and a display content of the display module. In one embodiment, in response to the MR device being in an energy-saving mode, the display module has a specific operating frequency less than a first preset threshold. In response to the MR device being in a high-performance mode, the display module has a specific operating frequency greater than a second preset threshold. In response to the display content of the display module including a video source at a specific frequency, the specific operating frequency of the display module is a multiple of the specific frequency of the video source.

As described above, the most intuitive feeling for users when using the MR device is visual experience, therefore, the working status of the display module will determine the user experience. For this reason, if the display module already has a specific working mode, even if there is the ambient light flicker that will cause the screen to flicker, it is still necessary to maintain the display module in the specific working mode, that is, in the step S2700, control the display module to display the target image at the specific working frequency at all times.

Due to the determination in the step S2400 that the ambient light flicker frequency is single and less than the specific operating frequency of the display module, it means that the ambient light flicker frequency is not equal to the specific operating frequency, and there is a frequency difference between the two. If the shooting frequency of the camera module is associated with the specific operating frequency, the problem of the image flicker may occur due to the frequency difference between the shooting frequency and the ambient light flicker frequency.

According to the fourth aspect of the disclosure, by executing the step S2500, the target shooting frequency of the camera module is not greater than the flicker frequency, that is, the working parameters of the camera module dynamically follow the changes in the ambient light flicker frequency, to solve the problem of the image flicker in the original image obtained by the camera module from the source.

But this has also raised another problem, that is, due to the mismatch between the shooting frequency of the original image generated by the camera module 210 and the display frequency of the image displayed by the display module 240, based on the existing MR device, the image finally displayed by the display module 240 may have problems such as misalignment, frame skipping, and discontinuity due to the mismatch between the shooting frequency and the display frequency, which can also cause users to visually feel that the display screen is “flickering”.

For this, a step S2600 needs to be executed through an image adaptation module 221. Based on the original image obtained by the camera module at the target shooting frequency, generate the intermediate images corresponding to the specific working frequency, and the target image displayed by the display module is obtain based on the intermediate images.

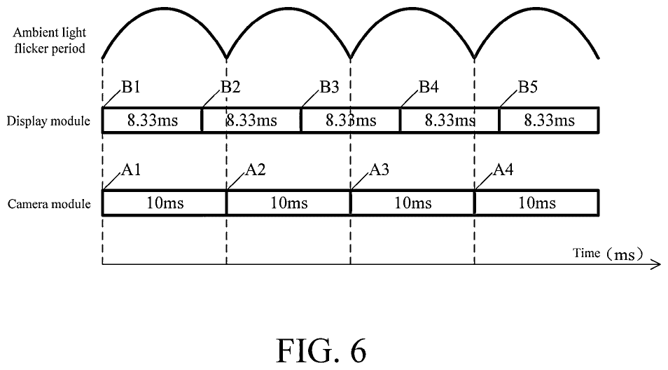

Please refer to FIG. 6 to understand the relationship between ambient light flicker cycle and the operating frequency of the display module and the camera module, in order to understand how to generate the intermediate images corresponding to the specific operating frequency based on the original image obtained by the camera module at the target shooting frequency in the step S2600. Refer to FIG. 6, in the step S2600, it is necessary to obtain the intermediate images at times B1, B2, B3, B4, B5, etc. corresponding to the operating frequency of the display module based on the original images generated by the camera module at times A1, A2, A3, A4, etc.

In one embodiment, the step S2600 further includes: at a target time corresponding to the specific operating frequency, generating the intermediate image of the target time based on two frames of original images before and after the target time.

In the above embodiments, generate the intermediate images corresponding to the specific operating frequency based on the original images obtained by the camera module at the target shooting frequency through inter-frame interpolation. In this embodiment, it is necessary to generate the intermediate image at time B2 based on the original images at times A1 and A2.

In this embodiment, since the original images before and after time B2 are determined, the intermediate image at time B2 can be determined by the changes between frames A1 and A2. And since the images of the frames A1 and A2 are determined, the accuracy of the intermediate image at time B2 determined according to this embodiment is relatively high.

It can be understood that the confirmation of the intermediate image at time B2 requires the original images at times A1 and A2, and time A2 is later than time B2. Therefore, based on this embodiment, the target image displayed by the display module is slightly delayed overall compared to the original image obtained by the camera module. It can be understood that even in existing technology, due to the need for the camera module to output images to the display module, and the possibility of a presence of other image processing processes during this process, the display module inevitably has a slight delay in displaying the target image compared to the original image obtained by the camera module. However, in order to generate B2 based on A1 and A2 without affecting the overall delay situation, it can still be controlled within a reasonable delay range.

In another embodiment, the step S2600 further includes: at a target time corresponding to the specific operating frequency, predicting the intermediate image of the target time based on a change pattern of a preset frame number of original images before the target time, and the original image that is one frame before the target time.

For example, in this embodiment, in order to obtain the intermediate image at time B4, it is firstly necessary to collect the change patterns of images A1, A2, and A3 (with a predetermined frame rate of 3 in this example, which is only illustrative and should not improperly limit the scope of protection of the disclosure). According to the above change patterns, predict the intermediate image at time B4 based on the original image at time A3.

In this embodiment, the intermediate image of the target time is obtained based on the original historical image, without waiting for the generation of a frame image after the target time, resulting in a small delay. In one embodiment, based on a change pattern of a preset frame number of original images, it can also obtain accurate intermediate images without sudden changes in the scene.

In another embodiment, the step S2600 further includes: obtaining view field movement data of a user according to a positioning sensor of the MR device; and at a target time corresponding to the specific operating frequency, performing at least one of parallel moving, scaling and distorting processes on the original image that is one frame before the target time based on the view field movement data, to generate the intermediate image of the target time.

For example, in this embodiment, in order to obtain the intermediate image at time B3, the original image at time A2 is firstly required, and the view field movement data of the user needs to be obtained through a positioning sensor of the MR device. The positioning sensor can include an eye tracking sensor and/or a head positioning sensor. The eye tracking sensor can provide movement data of the gaze point of the user. The head positioning sensor can output three degrees of freedom information of the head of the user, namely X/Y/Z and yaw, pitch, and roll information correspondingly calculated, and can also locate and output six degrees of freedom information of the head of the user, including (1) forward/backward, (2) up/down, (3) left/right, (4) yaw, (5) pitch and (6) roll, to provide movement data of the head of the user.

The view field movement data of the user can be comprehensively obtained through the gaze point movement data of the eye tracking sensor and/or the head movement data provided by the head positioning sensor, and the intermediate image at time B3 can be generated through at least one of parallel moving, scaling and distorting processes based on the original image at time A2.

In this embodiment, the intermediate image at the target time is obtained based on the original historical image, without waiting for the generation of a frame image after the target time, resulting in a small delay. At the same time, considering the view field movement data of the user, it can also obtain relatively accurate intermediate images that reflect the movement of the user without sudden changes in the scene.

Through the step S2600, it is possible to solve the problem of frame skipping and discontinuity in the displayed image caused by the inability to match the display module due to adjusting the working parameters of the camera module to follow the ambient light flicker. Therefore, the disclosure provides a solution for camera devices and display devices to adopt any refresh rate (the two may not match), which can dynamically adapt to changes in the ambient light and provide the possibility for further improving the refresh rate of display devices, laying the foundation for the further improvement and development of mixed reality performance.

In one embodiment, in the step S2500, maintaining the target shooting frequency of the camera module not greater than the flicker frequency at all times further includes: maintaining the target shooting frequency of the camera module being the flicker frequency at all times. By maintaining the target shooting frequency consistent with the flicker frequency, due to the absence of the frequency difference, it can make that the obtained original image does not have image flicker.

In another embodiment, in the step S2500, maintaining the target shooting frequency of the camera module not greater than the flicker frequency at all times further includes: maintaining the target shooting frequency of the camera module less than the flicker frequency at all times, and adjusting the target shooting frequency of the camera module to make the flicker frequency a multiple of the target shooting frequency. Due to the flicker frequency is a multiple of the target shooting frequency, it can also make that the obtained original image does not have image flicker.

In another embodiment, in the step S2500, maintaining the target shooting frequency of the camera module not greater than the flicker frequency at all times further includes: maintaining the target shooting frequency of the camera module less than the flicker frequency at all times, and adjusting the target shooting frequency of the camera module to make the flicker frequency a multiple of the target shooting frequency.

Furthermore, in this embodiment, it is necessary to adjust the exposure time of the camera module to match the flicker period of the ambient light, and the obtained original image does not have image flicker.

At this point, various specific implementation methods have been described to make the working parameters of the camera module follow the ambient light flicker to eliminate image flicker. The specific implementation method of the step S2500 may be chosen according to the actual situation of the camera module and the ambient light flicker.

In the fifth aspect of the disclosure, the MR device further includes a rendering module 250. The rendering module 250 outputs a virtual digital image at a rendering frequency. An image fusion module 230 enhances and renders the image obtained by the camera module 210 by fusing based on the digital reality image generated by the camera module 210 and the virtual digital image output by the rendering module 250, and outputs and displays a mixed target image.

Generally speaking, the rendering frequency of the rendering module 250 is consistent with the specific operating frequency of the display module. In this case, the target image is obtained by fusing the intermediate image output by the image adaptation module 221 and the rendered image.

But in some embodiments, there may be a specific rendering frequency that is inconsistent with the specific working frequency, resulting in the inability to match during image fusion.

For this, in another embodiment, in response to a presence of the specific rendering frequency in the rendering module and the mismatch between the specific rendering frequency and the specific working frequency, the rendering module is controlled to generate a rendered image at the specific rendering frequency. An image adaptation module 222 generates an intermediate rendered image corresponding to the specific operating frequency based on the rendered image at the specific rendering frequency, and the intermediate image output by the image adaptation module 221 and the intermediate rendered image output by the image adaptation module 222 can be fused at the specific operating frequency through the image fusion module 230 to obtain the target image.

The specific implementation of the image adaptation module 222 can refer to the specific implementation of the image adaptation module 221, which will not be repeated here.

Up to this point, the specific implementation method of the method for eliminating image flicker in an MR device provided in the fourth aspect of the disclosure has been described. In one embodiment, when the optimal frame rate of each module in the MR device is higher than the ambient light flicker frequency, and when only one flicker frequency in the entire shooting field of the ambient light reaches the flicker threshold, control the frame rate of the imaging and shooting image processing to remain not greater than the ambient light frequency, and the rendering and display frame rate can exceed the ambient light frequency. When displaying the shooting image, techniques such as inter-frame interpolation or time distortion are used to obtain the image at the required display time point. The optimal frame rate of each module in the MR device is higher than the ambient light flicker frequency, which may be due to the large number of moving objects in the rendering or shooting scene of the device. It is necessary to increase the frame rate of each module to reduce delay and display dynamic ghosting, or it may be due to the device being a wearable headset that needs to update the display content in real-time to improve display realism and reduce user discomfort and health hazards caused by factors such as delay and display dynamic ghosting.

According to the fourth aspect in the disclosure, the method for eliminating image flicker in an MR device can solve the problems of screen flicker or instability caused by changes in ambient light brightness and frequency mixing in imaging, rendering, and display by adjusting the shooting parameters of the camera module and generating intermediate images based on the original images of the camera module. The disclosure provides a solution for camera devices and display devices to adopt any refresh rate, which can dynamically adapt to changes in the ambient light and provide the possibility for further improving the refresh rate of display devices, laying the foundation for further improvement and development of mixed reality performance.

The fifth aspect of the disclosure also provides an MR device, as shown in FIG. 4, and the MR device at least includes a camera module 210 and a display module 240, and further includes at least one processor; and a memory coupled to the at least one processor. The memory includes an instruction stored therein. When the instruction is executed by the at least one processor, cause the MR device to perform the method for eliminating image flicker in the MR device as described in any one embodiment of the disclosure. It should be noted that at least one processor mentioned above may include processors in the camera module 210 and the display module 240.

The sixth aspect of the disclosure also provides a non-transitory computer-readable storage medium, storing a computer instruction thereon. When the computer instruction is executed by a processor, the steps of the method for eliminating image flicker in the MR device as described in any one of the embodiments above are implemented. Please refer to the description above for details, which will not be repeated here. In addition, it can be understood that the above-mentioned computer-readable storage medium can also be in the form of a system, including computer-readable storage sub media, to jointly implement the steps of the method for eliminating image flicker in the MR device described above through the computer-readable storage media.

The various illustrative logic modules and circuits described in connection with the embodiments disclosed herein can be realized or executed by general-purpose processors, digital signal processors (DSPs), application specific integrated circuits (ASICs), field programmable gate arrays (FPGAs) or other programmable logic devices, discrete gate or transistor logic, discrete hardware components or any combination thereof designed to perform the functions described herein. The general processor can be a microprocessor, but in some embodiments, the processor can be any conventional processor, controller, microcontroller or state machine. The processor can also be implemented as a combination of computing devices, such as a combination of DSP and microprocessors, microprocessors, one or more microprocessors cooperating with the DSP core or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor and the processor can read information from, and write information to, the storage medium. In one embodiment, the storage medium may be integral to the processor. The processor and the storage medium may reside in an ASIC. The ASIC may reside in a user terminal. In one embodiment, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blue-ray disc where disks usually reproduce data magnetically, while discs reproduce data optically with lasers. Combinations of the above should also be included within the scope of computer-readable media.

It should be understood that the scope of protection of the disclosure should be based on the appended claims, and should not be limited to the specific structures and components of the embodiments described above. Various changes and modifications to the embodiments within the spirit and scope of the disclosure, and these changes and modifications are also within the scope of protection of the disclosure.

What is claimed is:

1. A method for eliminating image flicker in an MR device, wherein the MR device at least comprises a camera module and a display module, and the method comprises:
in response to a presence of ambient light flicker that triggers human eye perception, determining a flicker frequency of the ambient light flicker;
determining whether the display module has a specific operating frequency according to a working status of the MR device;
in response to having the specific operating frequency and a mismatch between the specific operating frequency and the flicker frequency, controlling the display module to display target images at the specific operating frequency at all times, and at least dynamically adjusting a target shooting frequency of the camera module according to the flicker frequency and the specific operating frequency; and
controlling the camera module to obtain original images at the target shooting frequency, wherein the target images are obtained at least based on the original images.

2. The method according to claim 1, wherein the step of at least dynamically adjusting a target shooting frequency of the camera module according to the flicker frequency and the specific operating frequency further comprises:
maintaining the target shooting frequency of the camera module at the specific operating frequency at all times; and
dynamically adjusting exposure time of the camera module or performing brightness compensation on the original image according to the flicker frequency and the specific operating frequency.

3. The method according to claim 2, wherein the step of dynamically adjusting exposure time of the camera module or performing brightness compensation on the original image according to the flicker frequency and the specific operating frequency further comprises:
in response to the specific operating frequency being less than the flicker frequency, adjusting the exposure time of the camera module; or
in response to the specific operating frequency being greater than the flicker frequency, and/or in response to a presence of a plurality of flicker frequencies, performing the brightness compensation on the original image, wherein the target image is obtained based on the original image after the brightness compensation.

4. The method according to claim 3, wherein the exposure time of the camera module is adjusted to match a flicker period of ambient light.

5. The method according to claim 3, wherein the step of performing the brightness compensation on the original image further comprises:
for a preset number of historical original images prior to a current original image, separately obtaining a pixel brightness value of each pixel or a regional average brightness value of each local region from each of the historical original images; and
performing the brightness compensation on the current original image based on the pixel brightness values or the regional average brightness values of a plurality of the historical original images.

6. The method according to claim 5, wherein the step of separately obtaining a pixel brightness value of each pixel or a regional average brightness value of each local region from each of the historical original images further comprises:
obtaining a pixel chromaticity and brightness value of each pixel or a regional average chromaticity and brightness value of each local region form each of the historical original images based on each color channel, wherein
the step of performing the brightness compensation on the current original image based on the pixel brightness values or the regional average brightness values of a plurality of the historical original images further comprises:
for each color channel of the current original image, performing the brightness compensation based on the pixel chromaticity and brightness values or the regional average chromaticity and brightness values corresponding to the color channel of the plurality of historical original images.

7. The method according to claim 5, wherein the step of performing the brightness compensation on the original image also comprises:
determining a flicker region in the current original image based on the regional average brightness value of the plurality of historical original images, wherein
the step of performing the brightness compensation on the current original image based on the regional average brightness values of a plurality of the historical original images further comprises:
for the flicker region of the current original image, performing the brightness compensation based on a plurality of the regional average brightness values in the flicker region of the plurality of historical original images.

8. The method according to claim 1, wherein the step of at least dynamically adjusting a target shooting frequency of the camera module according to the flicker frequency and the specific operating frequency further comprises:
in response to a presence of only one single flicker frequency that is less than the specific operating frequency, maintaining the target shooting frequency of the camera module not greater than the flicker frequency at all times; and
generating intermediate images corresponding to the specific operating frequency based on the original images obtained by the camera module at the target shooting frequency, wherein the target image is obtained based on the intermediate image.

9. The method according to claim 1, wherein the MR device further comprises a rendering module, and the method further comprises:
determining whether the rendering module has a specific rendering frequency, wherein
in response to the rendering module having the specific rendering frequency, and the specific rendering frequency not matching the specific operating frequency, controlling the rendering module to generate rendered images at the specific rendering frequency, and generating intermediate rendered images corresponding to the specific operating frequency based on the rendered images at the specific rendering frequency, wherein the target image is also obtained based on the intermediate rendered image; or
in response to the rendering module not having the specific rendering frequency, controlling the rendering module to generate rendered images at the specific operating frequency, wherein the target image is also obtained based on the rendered image.

10. The method according to claim 1, wherein in response to a presence of only one single flicker frequency and the display module not having the specific operating frequency, maintaining the target shooting frequency of the camera module at the flicker frequency at all times, and controlling the display module to display target images at the flicker frequency.

11. The method according to claim 1, wherein the step of determining whether the display module has a specific operating frequency according to a working status of the MR device further comprises:
determining whether the display module has a specific operating frequency according to a working mode of the MR device and a display content of the display module, wherein
in response to the MR device being in an energy-saving mode, determining the display module has a specific operating frequency less than a first preset threshold;
in response to the MR device being in a high-performance mode, determining the display module has a specific operating frequency greater than a second preset threshold; and
in response to the display content of the display module including a video source at a specific frequency, determining the specific operating frequency of the display module to be a multiple of the specific frequency of the video source.

12. The method according to claim 1, wherein the step of at least dynamically adjusting a target shooting frequency of the camera module according to the flicker frequency and the specific operating frequency comprises: maintaining the target shooting frequency of the camera module not greater than the flicker frequency at all times,
the step of in response to a presence of ambient light flicker that triggers human eye perception, determining a flicker frequency of the ambient light flicker comprises: in response to a presence of only one single flicker frequency and a presence of specific operating frequency that is greater than the flicker frequency, generating intermediate images corresponding to the specific operating frequency based on original images obtained by the camera module at the target shooting frequency; and controlling the display module to display the target images, obtained based on the intermediate images, at the specific operating frequency.

13. The method according to claim 12, wherein the step of generating intermediate images corresponding to the specific operating frequency based on original images obtained by the camera module at the target shooting frequency further comprises:
at a target time corresponding to the specific operating frequency, generating the intermediate image of the target time based on two frames of original images before and after the target time.

14. The method according to claim 12, wherein the step of generating intermediate images corresponding to the specific operating frequency based on original images obtained by the camera module at the target shooting frequency further comprises:
at a target time corresponding to the specific operating frequency, predicting the intermediate image of the target time based on a change pattern of a preset frame number of original images before the target time, and the original image that is one frame before the target time.

15. The method according to claim 12, wherein the step of generating intermediate images corresponding to the specific operating frequency based on original images obtained by the camera module at the target shooting frequency further comprises:
obtaining view field movement data of a user according to a positioning sensor of the MR device; and
at a target time corresponding to the specific operating frequency, performing at least one of parallel moving, scaling and distorting processes on the original image that is one frame before the target time based on the view field movement data, to generate the intermediate image of the target time.

16. The method according to claim 12, wherein the step of maintaining the target shooting frequency of the camera module not greater than the flicker frequency at all times further comprises:
maintaining the target shooting frequency of the camera module being the flicker frequency at all times.

17. The method according to claim 12, wherein the step of maintaining the target shooting frequency of the camera module not greater than the flicker frequency at all times further comprises:
maintaining the target shooting frequency of the camera module less than the flicker frequency at all times, and adjusting the target shooting frequency of the camera module to make the flicker frequency a multiple of the target shooting frequency.

18. The method according to claim 17, wherein in response to the target shooting frequency being less than the flicker frequency, the exposure time of the camera module is adjusted to match a flicker period of the ambient light flicker.

19. An MR device, at least comprising a camera module and a display module, wherein the MR device further comprises at least one processor, and
a memory coupled to the at least one processor, wherein the memory comprises an instruction stored therein, and when the instruction is executed by the at least one processor, the MR device performs the method for eliminating image flicker in an MR device according to claim 1.

20. A non-transitory computer-readable storage medium, storing a computer instruction thereon, wherein when the computer instruction is executed by a processor, the method for eliminating image flicker in an MR device according to claim 1 is implemented.
